(19) United States
(12) Patent Application Publication
(10) Pub. No.: US 2006/0169548 A1
(43) Pub. Date: Aug. 3, 2006

(54) Electro-mechanical screw actuator assembly

(75) Inventors: Richard Corbett, Tours (IT); Ettore Berutti, Turin (IT)

Correspondence Address: MERCHANT & GOULD PC, P.O. BOX 2903, MINNEAPOLIS, MN, 55402-0903, US

(73) Assignee: Aktiebolaget SKF, Geoteborg (SE)

(21) Appl. No.: 10/539,303

(22) PCT Filed: Dec. 22, 2003
(86) PCT No.: PCT/EP03/14704

§ 371 Date: Jun. 16, 2005

(30) Foreign Application Priority Data
Dec. 20, 2002 (IT) TO2002 A 001104

(51) Int. Cl. F16D 55/08

(52) U.S. Cl. 188/72.8; 188/162

(57) ABSTRACT

The assembly comprises an electric motor (30) with a stator (31) and a rotor (34), a screw mechanism (60) including a rotatable nut (61) and a central screw (62) translatable along a given axis (x), and a planetary gear reduction system (50) disposed between the rotor (34) and the screw mechanism (60). The rotor (34) serves as a carrier for the satellite gears (52) of the reduction system (50).

The present invention refers to an electromechanical screw actuator assembly of the type mentioned in the preamble of claim 1.

Actuator assemblies of the above type are known, for example, from U.S. Pat. No. 6,315,092. These actuators are applied in various fields, for example in the automotive field for actuating brakes, friction clutches, gearboxes, etc. An electric motor, mounted within a housing fixable to the vehicle, drives for rotation a nut member of a screw mechanism through a gear reduction system. The screw mechanism comprises a screw connected to a piston actuating head which is imparted a reversible linear motion with a high actuating force.

The object of the present invention is to provide an electro-mechanical screw actuator assembly having few components, of compact dimensions and with a low inertia. Another object of the invention is to provide an actuator assembly particularly well suited for application onto a brake calliper and capable of performing also a parking brake function. A further object of the invention is to provide an electromechanical actuator assembly in which the electric motor is protected from contaminating agents such as grease, dirt and metal particles.

The foregoing, as well as other objects and advantages, that will be better understood herein after, are achieved according to the invention by an electromechanical actuator assembly having the features defined in the appended claims.

The constructional and functional features of a few preferred but not limiting embodiments of the invention will know be described with reference to the accompanying drawings, in which:

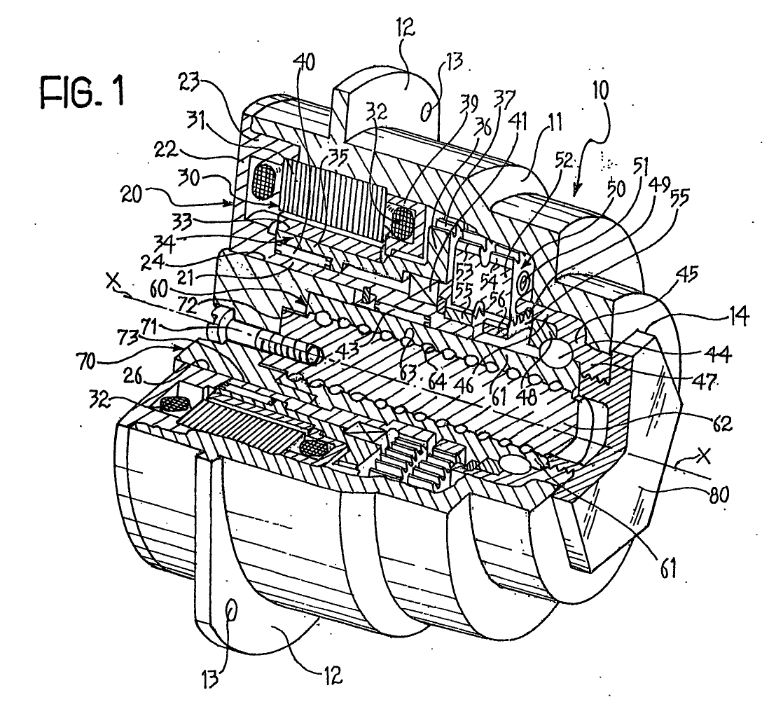

FIG. 1 is a partially sectioned prospective view of an actuator assembly according to the invention;

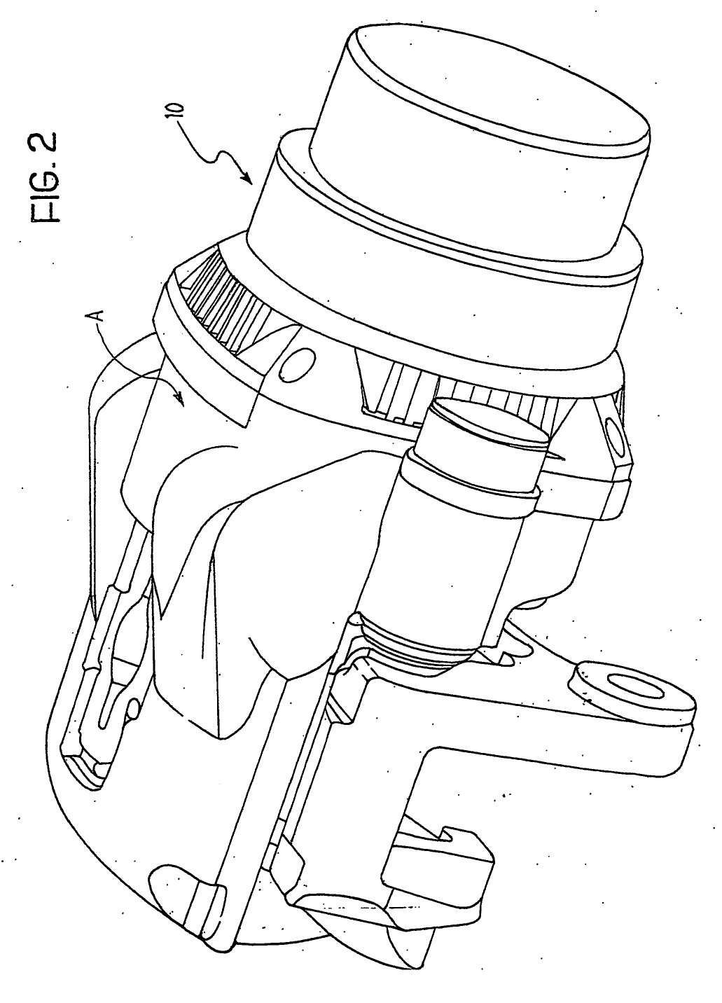

FIG. 2 is a perspective view showing the actuator assembly of FIG. 1 mounted onto the body of a brake calliper;

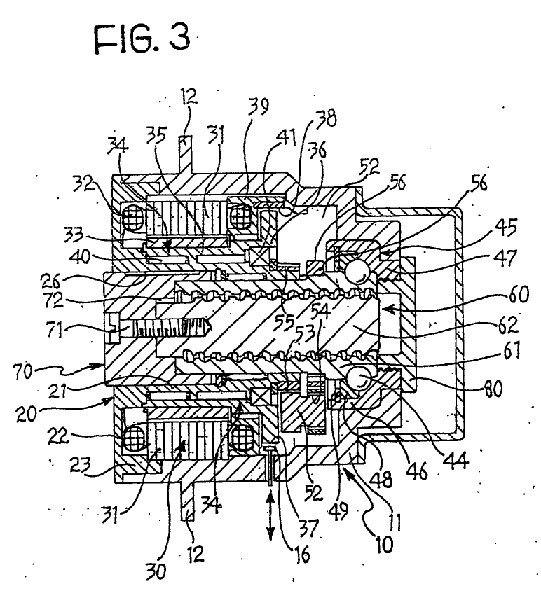

FIG. 3 is an axial longitudinal section of the assembly of FIG. 1;

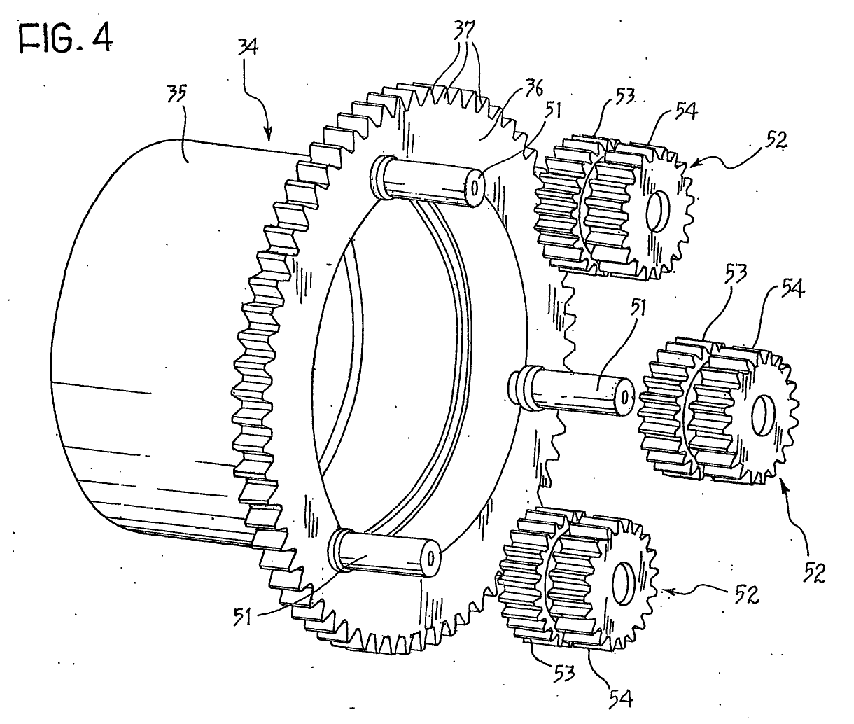

FIG. 4 is a perspective exploded view of a multifunctional rotor of the actuator assembly of FIG. 1;

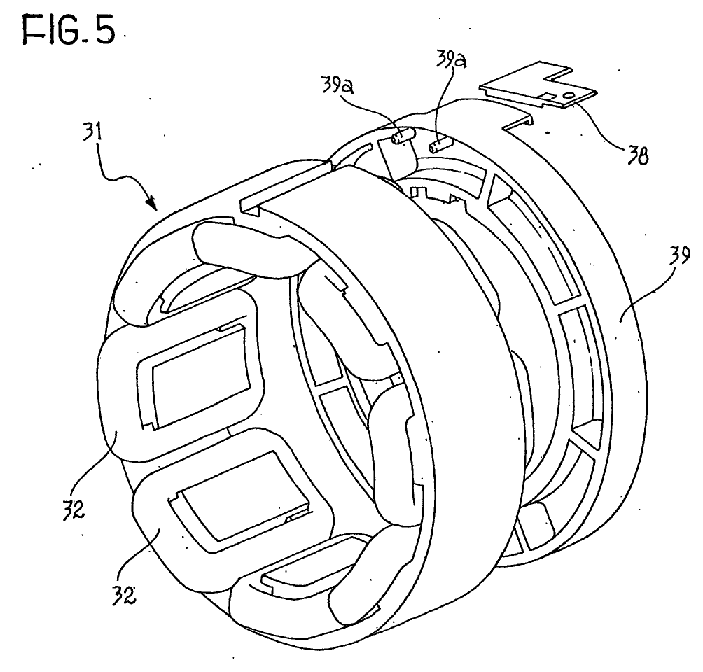

FIG. 5 is a perspective exploded view of a few components of the stator of the electric motor of the actuator assembly of FIG. 1;

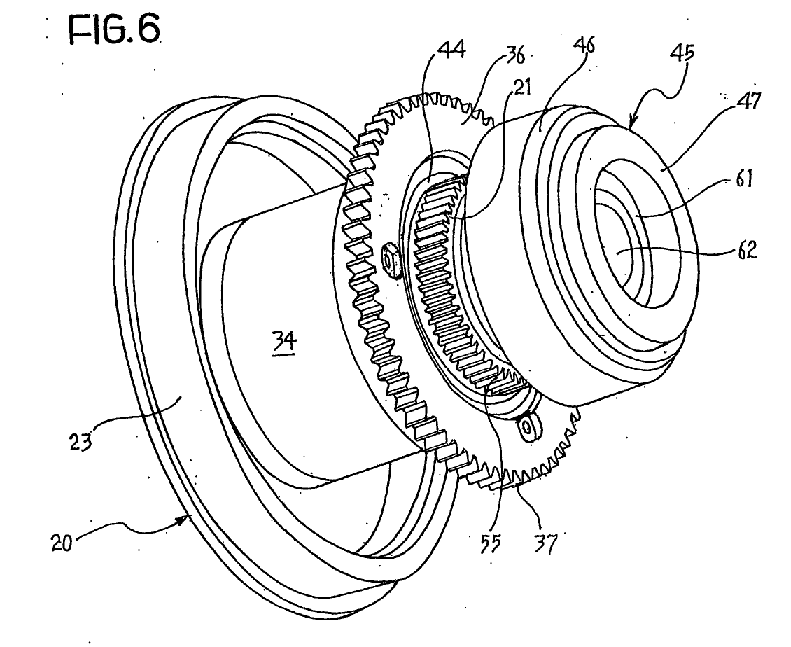

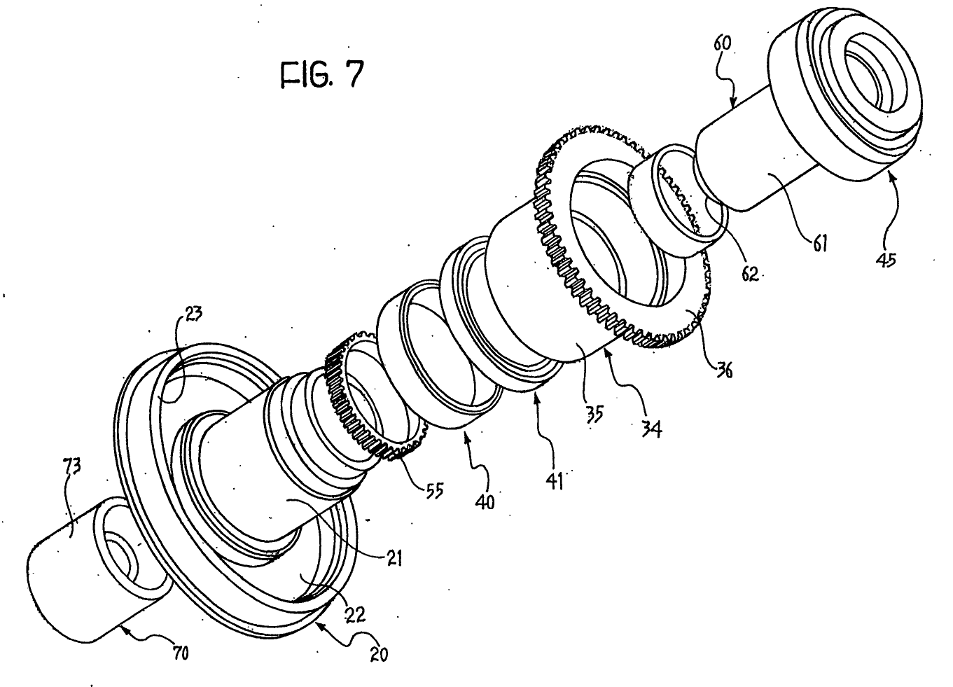

FIGS. 6 and 7 are a perspective view and an exploded perspective view of a subassembly of the assembly of FIG. 1.

With reference initially to FIG. 1, an electromechanical actuator assembly according to the invention is indicated overall 10. The assembly 10 comprises a housing. 11 that forms outer radial flanges 12 with bores 13 for fastening the assembly to the body of a brake calliper A, schematically shown in FIG. 2. Naturally, reference to this possible field of application should not in any way be interpreted as limiting the scope of the patent.

The housing 11 is rigidly coupled with a supporting body indicated 20 that forms a central tubular portion 21 extending inside the housing 11 coaxially to the central longitudinal axis x of the actuator assembly. The central tubular portion 21 supports internally and externally most of the rotating and translating transmission members of the actuator assembly, guaranteeing the correct alignment of their axes of rotation or translation and reducing to a minimum misalignments, eccentricities and the wear of these members.

At the output side of the actuator, the supporting body 20 forms a radial end wall 22, from which a tubular axial peripheral portion 23 extends for axially locking onto the housing 11 the stator 31 of an electric motor 30, preferably a brushless motor, incorporated in the actuator assembly. The stator windings are indicated 32. The peripheral portion 23 serves also for centring the housing 11 with respect to the central tubular portion 21.

The electric motor 30 comprises permanent magnets 33 fixed onto a tubular cylindrical portion 35 of a metallic rotor 34 rotatably mounted onto the central tubular portion 21 of the supporting body 20 through a needle bearing 40 and a ball bearing 41.

According to the invention, the rotor 34 forms integrally a radial flange 36 that allows to perform several functions, as will be explained in detail hereinafter.

The radial flange 36 serves as a planetary carrier for a planetary gear reduction system, indicated as a whole 50, through which the rotation of rotor 34 is transmitted to a nut member 61 of a screw mechanism 60. Fixed onto the planet carrier flange 36 are axially protruding pins 51 (FIG. 5) on which there are mounted satellite gears 52 each having two toothed portions 53, 54 adjacent to one another. The toothed portions 53 and 54 mesh, respectively, with a fixed gear 55, secured to an outer cylindrical surface of the central tubular portion 21 of the supporting body 20, and an output gear 56 fixed onto the cylindrical outer surface of nut member 61.

The radial flange 36 has a peripheral toothing 37 that is exploited, in accordance with the invention, to provide pulses that are detected by an electromagnetic position sensor 38 (FIG. 5). The constructional and operational features of the position sensor 38 (that may be of any known type, for example a Hall sensor) are not per se relevant to the understanding of the invention and will not therefore be described in detail herein. Suffice it there to say that the sensor 38 serves to provide signals indicative of the instantaneous angular position taken by the rotor, in order to control the rotation imparted to the rotor and, consequently, accurately control the force exerted by the screw actuator, in this example the braking force exerted by the brake pads of the brake calliper A on a brake rotor (not shown).

The sensor 38 is carried by an annular bracket 39 with a C-shaped cross section through pin portions 39a on one side of the stator 31. The same bracket 39 can advantageously serve as a support for further sensors (not shown) for controlling the switching of the brushless electric motor. The annular bracket 39 gives the additional advantage of protecting the electric motor from grease and metal particles released by the driving members of the actuator assembly.

Still according to the invention, the same peripheral metal toothing 37 of the rotor can also constitute a means for selectively locking the rotor in a given angular position through a toothed locking member 16. The movements of the locking member 16 between the engaged and disengaged positions with respect to the rotor toothing 37 are controlled, for example, by a further electric motor (not shown) for performing a parking brake function.

In its essentially central part, the nut 61 is rotatably mounted within the central tubular portion 21 of supporting body 20 through a needle bearing 43. Towards the opposite end (to the right in FIGS. 1 and 3), the nut 61 is rotatably supported with respect to the housing 11 through an angular contact ball bearing 44, the radially inner raceway of which is formed directly by the nut 61. The radially outer raceway is formed by a sleeve member 45 with an innermost cylindrical tubular portion 46 of greater diameter and an outermost cylindrical tubular portion of smaller diameter 47. A separate annular member 48 contributes to form part of the radially outer raceway of the bearing 44 and is accommodated in the greater diameter portion 46 of the sleeve 47 and axially locked by means of a retainer ring 49 (seeger ring).

In the illustrated example, the screw mechanism 60 is a ballscrew. The screw mechanism includes a central screw 62. The nut 61 and the screw 62 have respective threads 63 and 64 formed correspondingly and accommodating balls (not shown) through which the rotary motion of the nut 61 is converted into a linear movement of translation of the central screw 62 along the longitudinal axis x of the actuator assembly. At the output end (to the left in FIGS. 1 and 3), the screw 62 is non-rotatably coupled with a piston member 70. The coupling between the piston member 70 and the screw 62 is provided by a fastening screw 71 and a splined coupling or a flat 72 formed (FIG. 3) at the interface between the piston 70 and the screw 62 to prevent relative rotation between these two members.

The piston member 70 has a cylindrical surface 73 accommodated with a slight radial play and axially guided within a cylindrical bore 24 of the central tubular portion 21 of the supporting body 20. Preferably, a splined or equivalent coupling 26 is provided at the interface between the bore 24 and the cylindrical surface 73 of the piston to prevent relative rotation between the piston and the stationary parts of the actuator. To this end, also a key coupling may be used.

A threaded locking member 80 is screwed in the outer portion 47 of the sleeve member 45 to axially lock onto the housing 11 the subassembly comprised of the sleeve member 45, the angular contact ball bearing 44 and the nut 61.

When the electric motor 30 is activated, the rotor 34 drives the nut 61 for rotation through the planetary gear reduction system 50. The rotary motion of the nut is converted into a linear translation motion of the screw 62 through the recirculating balls (not shown), causing extension or withdrawal of the piston member 70, according to the direction of rotation imparted by the electric motor.

As will be appreciated, the invention entails the following advantages:
as the rotor 34 directly carries the satellites of the planetary gear reduction system, there is eliminated a transmission member prided with conventional solutions for transmitting motion from the rotor to other toothed members of the reduction system, and, consequently, the invention attains a reduction of the number of components, a reduction of weight and inertia, and the assembling is simplified;
the rotor toothing 37 performs the function of rotating member that allows the sensor 38 to detect pulses indicative of the position of the rotor;
the same toothing 37 offers the possibility of stopping the actuator through the locking member 16 that opposes rotation by acting in a point where the driving torque is low, and therefore the reaction forces on the locking member 16 are low;
the annular bracket 39 covers the electric motor 30 on the side facing the screw mechanism 60 and the reduction system 50. The electric motor is so protected from grease and metal particles. The bracket itself, besides carrying the position sensor 38, can conveniently carry also the switching sensors of the brushless electric motor 30.

It is to be understood that the invention is not limited to the embodiments described and illustrated herein, which are to be considered as constructional examples of the actuator assembly. Instead, the invention is likely to be modified as to shape and location of parts, constructional and functional details.

1. An electromechanical screw actuator assembly, of the type comprising:
an electric motor (30) with a stator (31) and a rotor (34),
a screw mechanism (60), including a rotatable nut (61) and a central screw (62) translatable along a given axis (x),
a planetary gear reduction system (50), disposed between the rotor (34) and the screw mechanism (60), for driving this mechanism,
wherein the rotor (34) carries a plurality of satellite gears (52) of the reduction system (50).

2. The actuator assembly of claim 1, wherein the rotor (34) has an outer peripheral toothing (37).

3. The actuator assembly of claim 2, wherein at least the toothing (37) of the rotor is made of metallic material.

4. The actuator assembly of claim 2, wherein the toothing (37) is formed as a single piece with the rotor (34).

5. The actuator assembly of claim 2, wherein the toothing (37) is carried or formed by a peripheral edge of a radial flange (36) of the rotor (34), the flange being provided with a plurality of axially protruding pins (51) for rotatably supporting the satellite gears (52).

6. The actuator assembly of claim 3, wherein it comprises position sensor means (38) operatively associated with the metallic toothing (37) in order to provide signals indicative of the angular position of the rotor (34).

7. The actuator assembly of claim 6, wherein the sensor means (38) are carried by an annular supporting bracket (39) mounted on one side of the stator (31).

8. The actuator assembly of claim 7, wherein the motor (30) is a brushless electric motor and that the bracket (39) carries further sensor means for controlling the switching of the brushless motor.

9. The actuator assembly of claim 2, wherein it further comprises at least a locking means (16) controlled for being selectively movable between a position engaged with the toothing (37) for locking rotation of the rotor (34) and a position disengaged from the toothing (37) for allowing rotation of the rotor.

10. The actuator assembly of claim 1, wherein each of the satellite gears (52) has two toothed portions (53, 54):
a first toothed portion (53) meshing with a fixed gear (55) and
a second toothed portion (54) meshing with a gear (56) fast for rotation with the nut (61).

11. The actuator assembly of claim 1, coupled with a brake calliper (A) for operating a braking force on a motor vehicle.
